(19) United States
(12) Patent Application Publication
(10) Pub. No.: US 2025/0256409 A1
(43) Pub. Date: Aug. 14, 2025

(54) DISASSEMBLABLE SUCTION BOX FOR A GRIPPER

(71) Applicant: DEFITECH, Entrelacs (FR)

(72) Inventor: Vincent BOUVAIS, Entrelacs (FR)

(73) Assignee: DEFITECH, Entrelacs (FR)

(21) Appl. No.: 18/856,405

(22) PCT Filed: Apr. 7, 2023
(86) PCT No.: PCT/FR2023/050514

§ 371 Date: Oct. 11, 2024

(30) Foreign Application Priority Data
Apr. 15, 2022 (FR) FR2203538

(51) Int. Cl. B25J 15/06; B25J 15/04

(52) U.S. Cl. CPC B25J 15/0616; B25J 15/045

(57) ABSTRACT

The suction box for a gripper includes first and second parts, one of the parts being intended to be coupled to at least one contact member of the gripper, the contact member being intended to come into contact with at least one object to be seized by the gripper, and the other of the parts being intended to be in fluidic communication with a vacuum generator, the suction box being configured to selectively adopt an assembled configuration in which a mechanical connection is established between the parts or a disassembled configuration in which the mechanical connection is cancelled. In the assembled configuration and in the disassembled configuration, the first part delimits an indentation. In the assembled configuration, the indentation participates in delimiting the suction cavity of the suction box. The suction box includes a seal which, in the assembled configuration, is interposed between the first and second parts.

### TECHNICAL FIELD OF THE INVENTION

The technical field of the invention relates to suction gripping, also so-called vacuum gripping, in particular the invention relates to a suction box for a gripper.

### PRIOR ART

It is known to use a handling device comprising a movable member and a gripper mounted on the movable member. For example, the movable member is a lifting cylinder, a lifting tube, a hoist, an articulated arm or a lifting gantry. The gripper can grasp one or more object(s) which could then be moved by actuation of the movable member.

The gripper can grasp at least one object using a vacuum gripping technique. To this end, the gripper may comprise a suction box coupled to a vacuum generation device, also so-called a vacuum generator. The function of the vacuum generator is to create a depression allowing evacuating the air present in the suction box in order to ensure gripping of one or more object(s) using one or more contact member(s) fastened on the suction box. The contact member where each contact member is arranged so as to cooperate with at least one suction orifice of the suction box so as to hold the object to be grasped by suction relative to the gripper. Thus, this contact member or each contact member could come into contact with the object to be grasped, then a suction is generated, in particular thanks to the vacuum generator, such that the object grasped by the gripper is held with respect to the gripper even during movements of the movable member. The aforementioned contact member may be a foam or a suction cup.

In general, it is desired to limit the weight of the gripper. A reduction in the weight of the gripper allows increasing the payload of the handling device, that is to say the weight that the handling device can carry. By reducing the weight of the gripper, it is possible to use, for a definite weight of objects to be grasped successively by the handling device, a handling device that is less powerful and less expensive in components. To this end, a suction box is known comprising a first plate, a spacer and a second plate, the spacer separating the first and second plates. Each of the first and second plates is made of aluminium or stainless steel or steel or composite materials comprising carbon fibers, the spacer is made of polyurethane or of PVC foam (an acronym standing for “polyvinyl chloride” in English) lasts so as to oppose crushing thereof during gripping of the object(s). The first plate, the spacer and the second plate are fastened together by screws or rivets.

It is useful for the suction box could be dismountable in order to enable cleaning thereof when the latter is fouled. Indeed, during gripping of the object(s) by the vacuum, particles/dust can be sucked by the suction box and the latter can foul the latter thereby the possibility of a degradation of its function participating in object(s) gripping. Although the aforementioned suction box based on plates separated by a spacer and assembled by screws could be dismounted, it is nevertheless still not optimized to increase the mechanical strength of the suction box in its assembled configuration where the spacer and the first and second plates are assembled together in a dismountable manner.

### OBJECT OF THE INVENTION

An object of the invention is a dismountable box having in particular a suitable mechanical strength.

To this end, the invention relates to a suction box for a gripper, said suction box comprising a first portion and a second portion, one amongst the first and second portions being intended to be coupled to at least one contact member of the gripper, said contact member being intended to come into contact with at least one object to be grasped by the gripper, and the other one amongst the first and second portions being intended to be in fluidic communication with a vacuum generator for example of the gripper, the suction box being configured to selectively adopt:
an assembled configuration in which a mechanical connection is established between the first and second portions so as to delimit respectively a first wall of the suction box and a second wall of the suction box opposite to the first wall, each of the first and second walls partially defining, in the assembled configuration, a suction cavity of the suction box;
a disassembled configuration in which said mechanical connection is suppressed;
   the suction box being such that:
the first portion defines, in the assembled configuration and in the disassembled configuration, a recess;
the recess participates in delimiting, in the assembled configuration, the suction cavity of the suction box;
the suction box comprises a seal interposed, in the assembled configuration, between the first and second portions.

This suction box has the advantage of being dismountable in order to enable cleaning in case of fouling, it therefore falls within a desire to seek to limit wastes since it could be cleaned in case of loss of efficiency of the gripper that comprises it related to a fouling of the suction box. After cleaning thereof, the suction box can be used again, thereby avoiding replacement thereof. The integration of the recess into the first portion allows conferring rigidity on this first portion tending to oppose crushing of the suction box during use thereof.

The gripping box may further comprise one or more of the following features. Hence, the following features correspond to particular embodiments that could complement what has been described hereinabove in the context of the suction box.

According to one feature, the first portion is a monolithic part.

The fact that the first portion is a monolithic part has the advantage that the first portion is made as one single part/block, which then has homogeneity and rigidity that are completely suitable for guaranteeing the solidity of the first portion.

According to one feature, the first portion is obtained by machining a plate.

The fact that the first portion is obtained by machining may be determined by analysis of this first portion. Machining has various advantages like allowing adapting the shape of the suction cavity on demand and/or guaranteeing mechanical cohesion within the first portion which then does not comprise assembly by fastening, for example by bonding, different parts.

According to one feature, the first portion is formed by two parts bonded together so as to delimit the recess.

Thus, two bonded parts forming the first portion is a solution enabling the first portion to behave like a rigid block having a satisfactory mechanical strength. Furthermore, this allows selecting, during manufacture, the two parts according to a suitable thickness in order to bond them to obtain a desired rigidity of the first portion. According to one feature, the second portion is a plate, in particular with a substantially constant thickness.

Thus, the fact that the second portion is in the form of a plate allows limiting the overall weight of the suction box.

According to one feature, the second portion delimits a recess participating in delimiting, with the recess delimited by the first portion, the suction cavity of the suction box in the assembled configuration.

Thus, the recess of the second portion allows conferring rigidity on this second portion tending to oppose crushing of the suction box during use thereof.

According to one feature, the second portion is a monolithic part, for example obtained by machining a plate,

The fact that the second portion is obtained by machining may be determined by analysis of this second portion. Machining has various advantages like allowing adapting the shape of the suction cavity on demand and/or guaranteeing mechanical cohesion within the second portion which then does not comprise assembly by fastening, for example by bonding, different parts.

According to one feature, the second portion is formed by two parts bonded together so as to form the recess of the second portion.

Two bonded parts thus forming the second portion is a solution enabling the second portion to behave like a rigid block having a satisfactory mechanical strength. Furthermore, this allows selecting, during manufacture, the two parts according to a suitable thickness in order to bond them to obtain a desired rigidity of the second portion.

According to one feature, the first portion comprises a composite material comprising a matrix and fibers, and/or the second portion comprises a composite material comprising a matrix and fibers.

The composite material, whether that of the first portion or that of the second portion, has the advantage of offering good mechanical strength while allowing limiting, where appropriate, the weight of the first portion and/or of the second portion. In this sense, the weight of the suction box can be limited, which is advantageous in the operation of an articulated arm equipped with a gripper comprising this suction box for carrying out object(s) gripping.

According to one feature, the suction box comprises a bumper extending, in the assembled configuration, along a lateral edge of the first portion and a lateral edge of the second portion, said bumper comprising a bead compressed, in the assembled configuration, between the first and second portions.

Thus, the bumper allows forming a protection for damping the impacts that the suction box might undergo during handling thereof, for example via an articulated arm. The bead has the advantage of facilitating the assembly of the bumper to the rest of the suction box. The bumper also has the advantage in the field of people protection when the suction box is used in the context of cobotics where impacts are normed for people protection.

According to one feature, the seal is formed by the bead.

Thus, since the bumper also participates in the sealing function of the suction box, this allows limiting the number of elements to be handled during assembly and disassembly of the suction box.

According to one feature, the suction box comprises assembly members each comprising a male portion comprising a support head and a female portion comprising a support head, and, in the assembled configuration and for each assembly member, the male portion of said assembly member is fitted into the female portion of said assembly member so that the support head of the male portion of said assembly member and the support head of the female portion of said assembly member participate in the implementation of a bias of the first portion and of the second portion in the direction of one other.

Thus, the assembly members allow ensuring a suitable holding of the first and second portions with each other while enabling a suitable compression of the seal. 5

According to one feature, the suction box comprises a third portion arranged, in the assembled configuration, between the first portion and the second portion and, in the assembled configuration:
the seal is compressed between the third portion and the second portion;
the suction box comprises an additional seal compressed between the third portion and the first portion.

Thus, the third portion allows increasing the volume of the suction cavity by adjusting the separation distance between the first and second walls according to the thickness of the suction box. The porosity of an object to be grasped is a parameter which may require increasing the volume of the suction cavity in order to achieve a satisfactory gripping of the object. Thus, by enabling the presence of such a third portion, it is possible to confer good modularity on the suction box. Moreover, such a third portion could be added throughout the service life of the suction box to extend it in order to adjust it to its intended purpose, of course to the detriment of weight and gripping speed.

According to one feature, the first portion comprises at least one rib which participates in the delimitation of the recess of the first portion.

Thus, one or more rib(s) serve as a reinforcement to oppose crushing of the suction box according to its thickness measured according to a direction transverse to substantially parallel opposite faces of the suction box respectively delimited by a surface of the first portion directed towards the outside of the suction box and by a surface of the second portion directed towards the outside of the suction box.

The invention also relates to a gripper comprising:
at least one suction box as described;
at least one contact member intended to come into contact with at least one object to be grasped by the gripper;
   said contact member being coupled to one amongst the first or second portions of said suction box.

Thus, the maintenance of the gripper may be carried out since its suction box is dismountable.

The contact member may be a foam or a suction cup. These are two types of known contact members allowing grasping one or more object(s) of different types.

The invention also relates to a suction device for a gripper, said suction device having a plurality of suction chambers. The suction device comprises a plurality of suction boxes as described, the suction cavity of each of the suction boxes corresponding to one amongst said suction chambers and the suction device comprises a support made in one-piece locally delimiting the first portions or the second portions of the suction boxes.

Thus, this suction device has the advantage of allowing grasping different objects simultaneously each via one of the suction boxes, considering that each suction box then allows, for example, grasping only one of the objects, or the advantage of overcoming a weakness of one of the suction boxes of at least two suction boxes ensuring gripping of the same object.

The invention also relates to a method for manufacturing the suction box, the method comprising a step of forming the first portion of the suction box, a step of forming the second portion of the suction box and an assembly step to obtain the assembled configuration of the suction box, the step of forming the first portion comprising a step of machining a plate to form the recess or a step of assembling two plates, one of which is apertured to participate in the formation of the recess.

Such a manufacturing method has the advantage of being easy to implement while allowing obtaining a suction box that is easy to dismount in particular for maintenance thereof.

Other advantages and features will appear from the following detailed description.

### BRIEF DESCRIPTION OF THE DRAWINGS

The invention will be better understood upon reading the following detailed description, given only as non-limiting example and made with reference to the appended drawings and listed hereinbelow.

FIG. 1 schematically illustrates a handling device comprising an articulated arm equipped with a gripper for handling an object.

FIG. 2 schematically illustrates, according to a perspective view, an embodiment of a gripper according to the invention.

FIG. 3 schematically illustrates, according to a perspective view, a suction box of the gripper of FIG. 2 according to an assembled configuration of this suction box.

FIG. 4 schematically illustrates, according to a perspective view, a disassembled configuration according to a particular embodiment of the suction box of FIG. 3.

FIG. 5 schematically illustrates, according to a particular embodiment, a sectional view of the suction box of the type of FIG. 3 in its assembled configuration.

FIG. 6 illustrates the disassembled configuration of the suction box as shown in FIG. 5.

FIG. 7 schematically illustrates, according to a particular embodiment, a sectional view of the suction box of the type of FIG. 3 in its assembled configuration.

FIG. 8 illustrates the disassembled configuration of the suction box as shown in FIG. 7.

FIG. 9 schematically illustrates, according to a particular embodiment, a sectional view of the suction box of the type of FIG. 3 in its assembled configuration.

FIG. 10 illustrates the disassembled configuration of the suction box as shown in FIG. 9.

FIG. 11 schematically illustrates, according to a particular embodiment, a sectional view of the suction box of the type of FIG. 3 in its assembled configuration.

FIG. 12 illustrates the disassembled configuration of the suction box as shown in FIG. 10.

FIG. 13 schematically illustrates, according to a particular embodiment, a sectional view of the suction box of the type of FIG. 3 in its assembled configuration.

FIG. 14 illustrates the disassembled configuration of the suction box as shown in FIG. 13.

FIG. 15 schematically illustrates, according to a particular embodiment, a sectional view of the suction box of the type of FIG. 3 in its assembled configuration.

FIG. 16 illustrates the disassembled configuration of the suction box as shown in FIG. 15.

FIG. 17 schematically illustrates, according to a perspective view, a particular embodiment of the suction box of the type of FIG. 3 in its disassembled configuration.

FIG. 18 illustrates a schematized version, according to a sectional view, of a particular embodiment of the suction box of the type of FIG. 3 according to the principle of FIG. 17.

FIG. 19 schematically illustrates a particular embodiment of the suction box according to a sectional view of the suction box of the type of FIG. 3.

FIG. 20 schematically illustrates a particular embodiment of a suction device with several suction boxes.

FIG. 21 schematically illustrates, according to a perspective view, a particular embodiment of the gripper.

FIG. 22 schematically illustrates, according to a perspective view, a particular embodiment of the gripper.

FIG. 23 schematically illustrates the gripper of FIG. 22 according to an exploded view showing in particular the disassembled configuration of the suction box.

FIG. 24 schematically illustrates, according to a perspective view, a particular embodiment of the gripper equipped with suction cups.

In these figures, the same references are used to refer to the same elements or similar elements with regards to their function. The figures are not necessarily plotted to scale in order to facilitate understanding of these figures.

### DETAILED DESCRIPTION

By “substantially parallel”, it should be understood parallel or parallel within a 10 degrees margin.

By “substantially constant thickness”, it should be understood a thickness that is constant or that varies by more or less 10% around a reference value of this thickness.

By “comprised between two values”, it should be understood that these two values form the bounds of a corresponding range for which the two values are included.

In particular, by “sealing”, reference is made to airtightness.

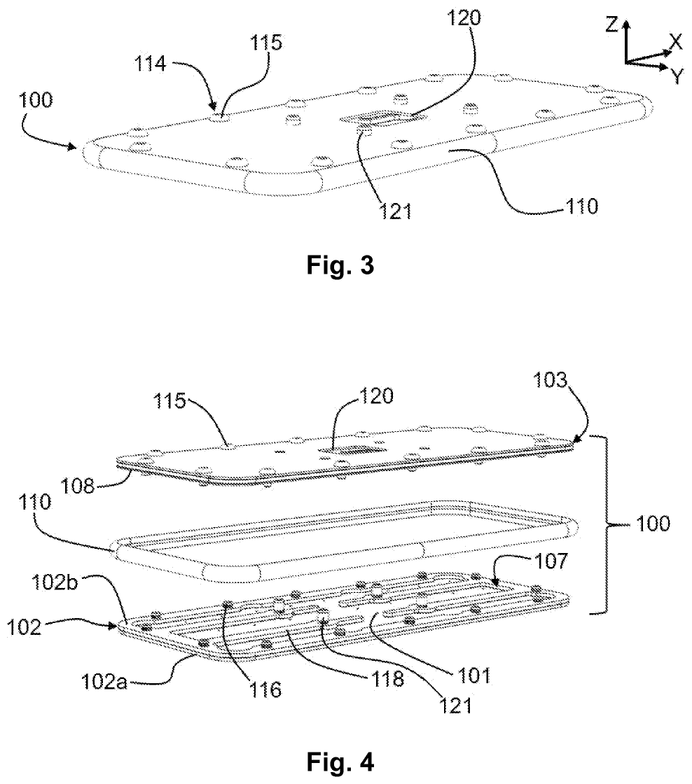

An orthonormal reference frame XYZ is defined, this reference frame is represented by the axes X, Y and Z in FIG. 3. The “below” concept is defined according to the axis Z.

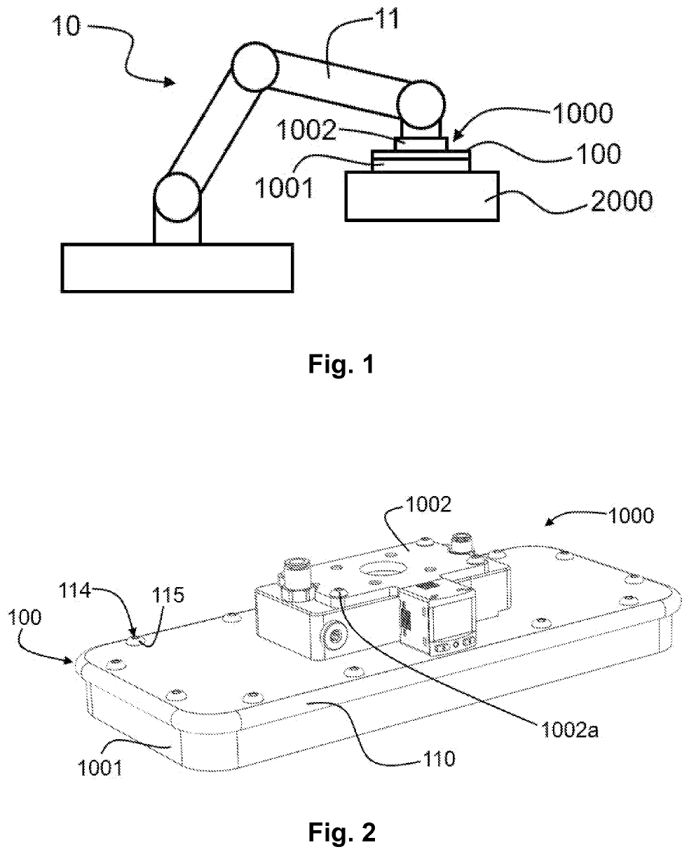

Gripping at least one object 2000, as shown for example in FIG. 1, by a gripper 1000 allows grasping said at least one object 2000 in order to handle and/or move it. Next, what applies to gripping of the object 2000 can be applied, where appropriate, to the simultaneous gripping of several objects 2000 by the same gripper 1000. To ensure gripping, the gripper 1000 may comprise a suction box 100 coupled to at least one contact member 1001 belonging to the gripper 1000. The contact member 1001 is intended to come into contact with the object 2000 to be grasped by the gripper 1000. Furthermore, during use of the gripper 1000, the suction box 100, and in particular its interior, is in fluidic communication with a vacuum generator 1002 (shown for example in FIGS. 1, 2, 21, 22 and 23).

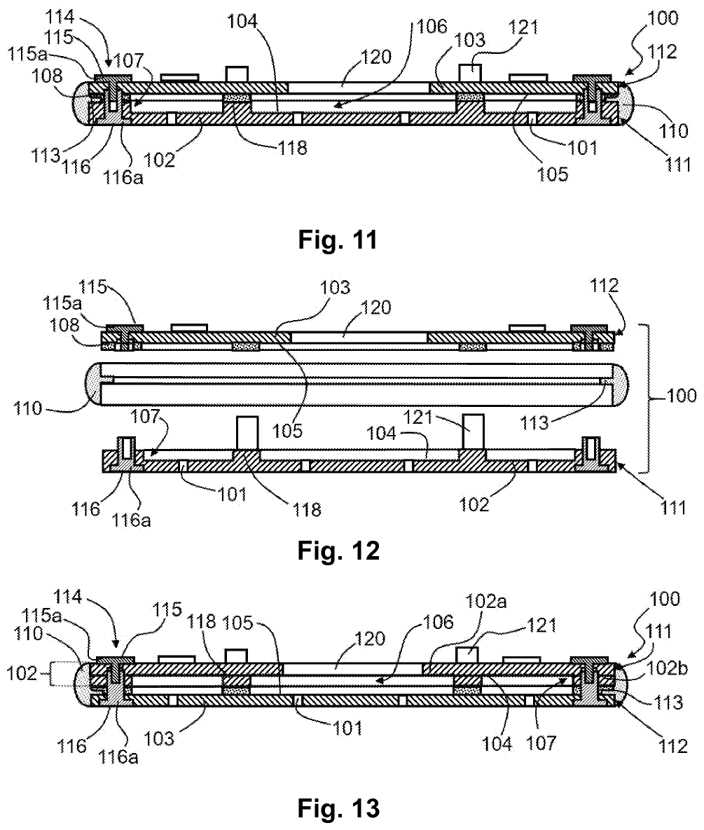

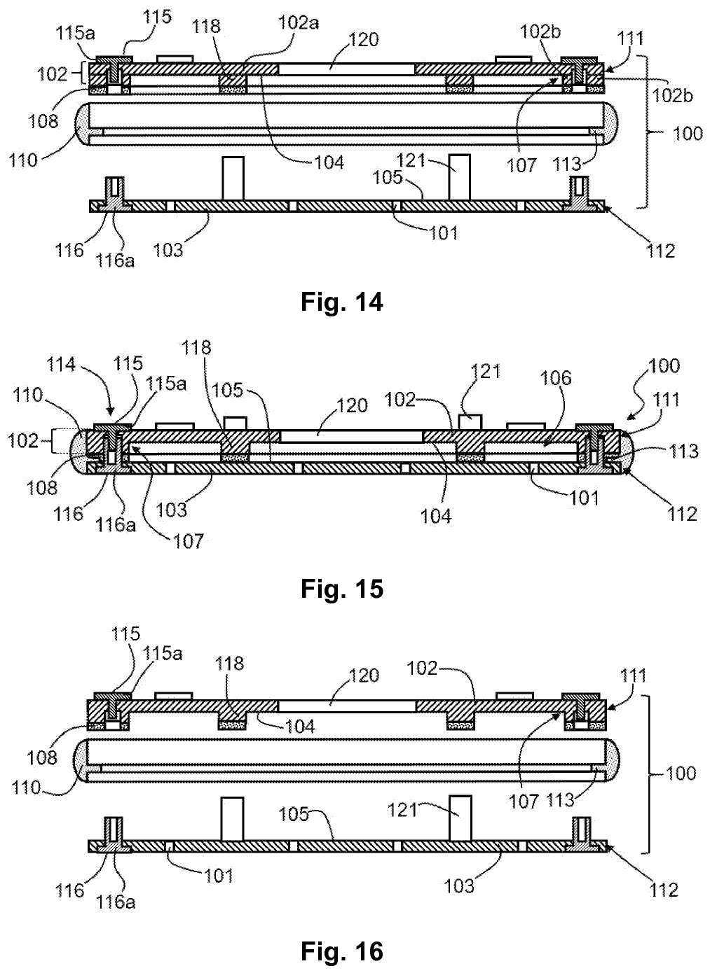

Conventionally, the vacuum generator 1002 may be configured to suck the interior of the suction box 100 in order to create a depression allowing evacuating the air present in the suction box 100 and therefore creating a depression at orifices 101 (shown in particular in FIGS. 4 to 19 and 23) comprised in the suction box 100 in order to ensure, using the contact member(s) 1001, gripping of the object 2000. These orifices 101 are open-through and each connects the outside of the suction box 100 to the interior of the suction box 100.

The gripper 1000 may comprise this vacuum generator 1002. In this case, the vacuum generator 1002 may be mounted on the suction box 100 and may comprise a Venturi cartridge participating in ensuring the suction function of the vacuum generator 1002.

Alternatively, the vacuum generator 1002 may be remote from the gripper 1000 to which it does not therefore belong. The vacuum generator 1002 is then considered to be remote and may be connected to the gripper 1000 by means of a hose allowing sucking the content of the suction box 100. It is then the hose which enables the fluidic communication of the vacuum generator 1002 with the suction box 100 during use of the gripper 1000. In this case, the vacuum generator 1002 may comprise a turbine or a vacuum pump allowing sucking the air contained in the suction box 100.

Thus, the suction box 100 may be coupled to the vacuum generator 1002 by direct mounting of the vacuum generator 1002 on the suction box 100 or via the hose connecting the suction box 100 to the vacuum generator 1002.

The aforementioned hose may be replaced by any other system allowing connecting the vacuum generator 1002 to the suction box 100.

In the principle of FIG. 1, a handling device 10 may comprise the gripper 1000 for example mounted on a movable member 11, such as an articulated arm, which comprises the handling device 10. In the case where the vacuum generator 1002 is remote from the gripper 1000 (a case that is not shown), it is then the handling device 10 which comprises the vacuum generator 1002.

The invention relates to the suction box 100 for the gripper 1000 with reference to FIGS. 1 to 24 which show different embodiments of the suction box 100. The suction box 100 comprises a first portion 102 and a second portion 103. One amongst the first portion 102 and the second portion 103 is intended to be coupled (for example by mounting or gluing) to the at least one contact member 1001 of the gripper 1000 (hereinafter, which applies to the contact member 1001 could be applied to several contact members 1001 that the gripper 1000 may comprise), said contact member 1001 being intended to come into contact with said at least one object 2000 to be grasped by the gripper 1000, and the other one amongst the first portion 102 and the second portion 103 is intended to be in fluidic communication with the vacuum generator 1002 that the gripper 1000 may comprise or remote from the gripper 1000 as mentioned hereinabove.

By “said other one amongst the first portion 102 and the second portion 103 is intended to be in fluidic communication with the vacuum generator 1002”, it should herein be understood that said other one amongst the first portion 102 and the second portion 103 is configured to enable the passage, towards the vacuum generator 1002, of a fluid (in the present case in particular air) present inside the suction box 100. In other words, said other one amongst the first portion 102 and the second portion 103 is configured to enable a fluidic communication between the interior of the suction box 100 and the vacuum generator 1002, for example, whether by direct mounting of the vacuum generator 1002 on the suction box 100 or by using the aforementioned hose then connecting for example said other one amongst the first portion 102 and the second portion 103 to the vacuum generator 1002.

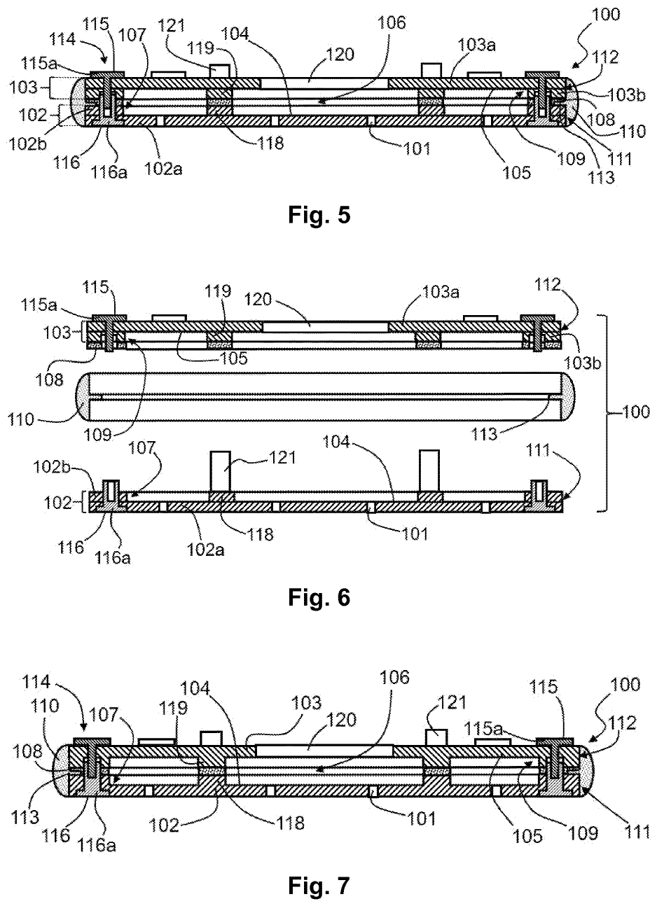

In particular, FIG. 3 shows, viewed from the outside, the suction box 100 which could then have different structural embodiments as one could deduce from FIGS. 4 to 19. For example, FIGS. 5 to 16, 18 and 19 show sectional views of these different embodiments, each sectional view being according to a sectional plane of the suction box 100 of the type of FIG. 3 parallel to the plane defined by the axes Z and Y.

For example, in FIGS. 4 to 11, the first portion 102 is shown below the second portion 103 and is coupled (FIG. 2) or is intended to be coupled (FIGS. 4 to 12 and 17 to 19) to the contact member 1001 or to several contact members 1001 meaning that the first portion 102 comprises the orifices 101.

For example, in FIGS. 13 to 16, the second portion 103 is shown below the first portion 102 and is coupled (FIG. 2) or is intended to be coupled (FIGS. 13 to 16) to the contact member 1001 or to a plurality of contact members 1001 meaning that the second portion 103 comprises the orifices 101.

Thus, in general, said one amongst the first and second portions 102, 103 intended to be coupled to the contact member 1001 may comprise the orifices 101 enabling the passage of air between the outside of the suction box 100 and the interior of the suction box 100; in particular, this air passage may be generated during use of the gripper 1000 forcibly by the vacuum generator 1002 which sucks the interior of the suction box 100, in particular via the aforementioned fluidic communication.

In particular, this suction box 100 is intended to be dismountable. To this end, said suction box 100 is configured to selectively adopt:
an assembled configuration in which a mechanical connection is established between the first portion 102 and the second portion 103, as illustrated for example in FIGS. 1, 2, 3, 5, 7, 9, 11, 13, 15, 18, 20, 21 and 22, so as to respectively delimit a first wall 104 of the suction box 100 and a second wall 105 of the suction box 100 opposite to the first wall 104, each of the first wall 104 and of the second wall 105 partially delimiting, in the assembled configuration, a suction cavity 106 of the suction box 100 (this suction cavity 106 corresponding in particular to the interior of the aforementioned suction box 100);
a disassembled configuration in which said mechanical connection is suppressed, as illustrated, for example, in FIGS. 4, 6, 8, 10, 12, 14, 16, 17 and 23.

The first portion 102 delimits, in the assembled configuration and in the disassembled configuration, a recess 107. The recess 107 participates in delimiting, in the assembled configuration, the suction cavity 106 of the suction box 100. The suction box 100 comprises a seal 108 interposed, in the assembled configuration, between the first portion 102 and the second portion 103. Of course, the seal 108 participates, in the assembled configuration, in ensuring sealing of the suction cavity 106 between the first portion 102 and the second portion 103. In particular, the first wall 104 forms an inner surface, delimited by the first portion 102, of the suction cavity 106 and the second wall 105 forms an inner surface, delimited by the second portion 103, of the suction cavity 106.

Such a suction box 100 has the advantage of being dismountable in order to enable cleaning thereof in case of fouling, it is therefore in line with a desire of seeking to limit wastes since it can be cleaned in case of loss of efficiency of the gripper 1000 related to a fouling of the suction box 100. After cleaning thereof, the suction box 100 can be used again, thereby avoiding replacement thereof.

The integration of the recess 107 into the first portion 102 allows conferring rigidity on this first portion 102 tending to oppose crushing of the suction box 100 during use thereof, that is to say during gripping of an object 2000 by the gripper 1000 using the vacuum generator 1002. The addition of rigidity is ensured whether the recess 107 is on the side intended to be coupled to the contact member 1001 like in the case, for example, of FIGS. 4 to 12, 18, 19 and 23, or on the opposite on the side intended to be coupled to the contact member 1001, where appropriate, on the side intended to cooperate with a vacuum generator 1002 as shown in FIGS. 13 to 16.

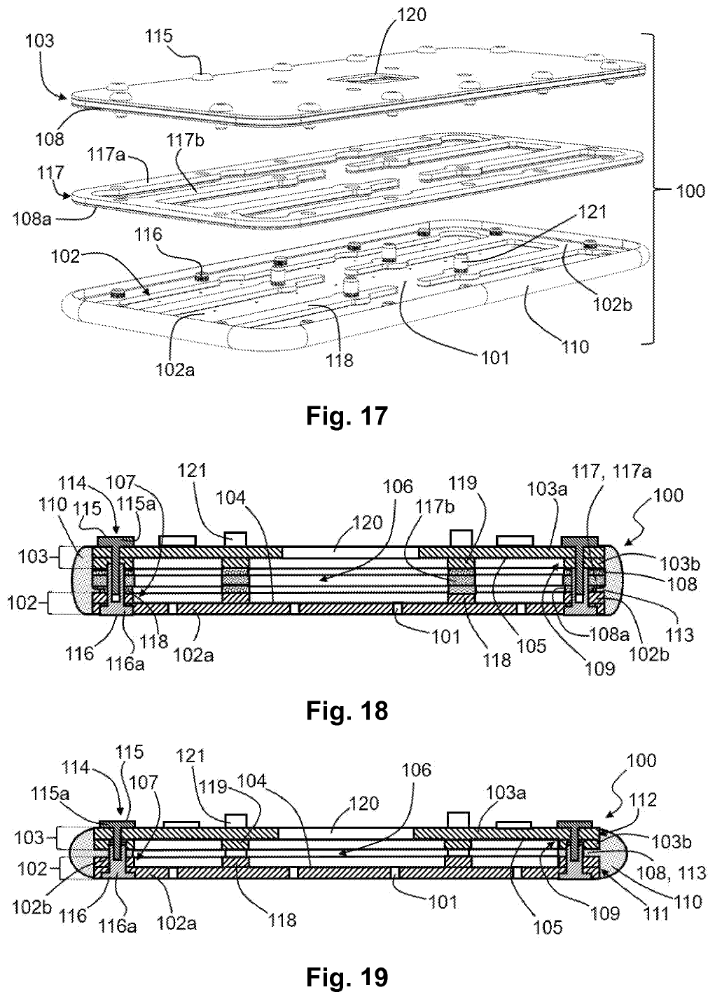

Moreover, another advantage is that, where appropriate, this suction box 100 allows limiting the number of parts to be handled and to align during assembly of the suction box 100 or to be handled during disassembly of the suction box 100 in particular when the latter does not comprise an intermediate element, hereinafter corresponding to an independent third portion 117, in particular as shown in FIGS. 17 and 18, participating in delimiting the structure of the suction box 100 (and therefore the thickness of its suction cavity 106 according to the axis Z) between the first and second portions 102, 103 as will be seen later on. Thus, although dismountable, the suction box 100 could remain relatively thin, which allows limiting the volume of the suction cavity 106 and conferring a satisfactory gripping speed on the gripper 1000.

In general, during the operation of the gripper 1000, a depression at the level of the contact member 1001 can be generated by the vacuum generator 1002 which enables the establishment of an air flow passing through the suction box 100 by entering into the suction cavity 100 through the orifices 101 and then coming out of the suction box 100 through an opening 120 comprised in the suction box 100, this opening 120 being formed in the first or second portion 102, 103 opposite to said one amongst the first and second portions 102, 103 intended to be coupled to the contact member 1001 comprising the orifices 101. Thus, the opening 120 enables the aforementioned fluidic communication. Hence, the opening 120 is configured to participate in establishing the fluidic communication between the suction cavity 106 and the vacuum generator 1002.

Where appropriate, in order to facilitate mounting of the vacuum generator 1002 on the suction box 100 and to couple it to the opening 120 of the suction box 100, the suction box 100 may comprise assembly means 121 like inserts with threaded hollow bodies for receiving each of a screw 1002a participating in fastening of the vacuum generator 1002 to the suction box 100. In FIGS. 3, 4, 17 and 23, one could see four assembly means 121 around the opening 120 for the corresponding box 100. In particular, the means 121 extend throughout the suction box 100.

In the assembled configuration, a lateral peripheral edge is at least partially delimited by the first and second portions 102, 103. In other words, the first and second portions 102, 103 participate in delimiting the lateral peripheral edge.

The seal 108 allows participating in sealing of the suction box 100 more particularly at the level of the lateral peripheral edge. In other words, the seal 108 allows avoiding pressure drops, in particular in air, laterally to the suction box 100 during the operation of the gripper 1000, that is to say when the vacuum generator 1002 is active to generate suction via the suction box 100 in order to grasp an object 2000.

The seal 108 may be made of EPDM (this acronym being well-known for designating ethylene-propylene-diene monomer) or of silicone and the seal 108 may, for example, be in the form of a foam. This is quite particularly suitable to ensure the desired sealing function.

The seal 108 can at least partially adopt a closed loop shape, intended to ensure the desired sealing of the suction box 100, and therefore of its suction cavity 106, at the level of the lateral peripheral edge formed when the suction box 100 is in its assembled configuration.

For example, in the assembled configuration, the seal 108 may be compressed between the first portion 102 and the second portion 103. The seal 108 could then be in contact, on the one hand, with the first portion 102 and, on the other hand, with the second portion 103.

The seal 108 may be fastened, for example by bonding with a suitable adhesive such as a double-sided adhesive, to one amongst the first and second portions 102, 103 (although this is not limiting, in the illustrated examples, the seal 108 is in particular bonded to the first portion 102 in FIGS. 13 to 16, and is in particular bonded to the second portion 103 in FIGS. 4 to 12 and 17); as a result, in the disassembled configuration, the seal 108 remains secured to said one amongst the first and second portions 102, 103 to which it is fastened. This has the advantage of limiting the number of parts to be handled during the phase of assembling and/or disassembling the suction box 100.

In particular, when the seal 108 is glued/fastened by gluing to one amongst the first and second portions 102, 103, this seal 108 may be, in the assembled configuration, in simple contact with the other one amongst the first and second portions 102, 103, whereby, in the disassembled configuration, the seal 108 remains fastened by gluing to one amongst the first and second portions 102, 103 and remote from the other one amongst the first and second portions 102, 103. This corresponds in particular to what is illustrated in FIGS. 5 to 16.

As a result of what has been described before, the presence of the recess 107 of the first portion 102 allows conferring a satisfactory mechanical strength on the suction box 100 while allowing participating in laterally delimiting the suction cavity 106 of the suction box 100. Henceforth, there are different means to enable the presence of this recess 107:
the first portion 102 may be a monolithic part (for example in the form of a plate with a variable thickness) as illustrated for example in FIG. 7, 8, 11, 12, 15, 16, to this end, the first portion 102 may be obtained by machining a plate, what a person skilled in the art could easily observe;
the first portion 102 may be formed by two parts 102a, 102b bonded together so as to delimit the recess 107 as illustrated for example in FIGS. 4, 5, 6, 9, 10, 13, 14, 17, 18, 19.

The two parts 102a, 102b bonded together may be bonded by a two-component epoxy glue. A person skilled in the art will be able to use epoxy two-component glues well known per se, like for example LOCTITE® EA 9461 or ARALDITE® 2015-1.

The mentioned machining of the plate from which the first portion 102 may be derived may be carried out using a milling cutter.

The first portion 102 formed by two parts 102a, 102b may be obtained by bonding together a first plate with a second plate (thereby forming the two parts 102a, 102b, respectively) cut in a suitable manner, for example, using a milling cutter to remove portions thereof so that cutting of the second plate allows, with the cooperation of the first plate, obtaining the recess 107 following bonding.

In general, the recess 107 of the first portion 102 may result from the fact that the periphery of the face of the first portion 102 delimiting the first wall 104 has a loop-shaped elevation obtained by milling of the plate or by one of the two parts 102a, 102b. This elevation participates with the first wall 104 in delimiting, in the assembled configuration, the suction cavity 106.

The second portion 103 may be a plate, as shown, for example, in FIGS. 9 to 16. This plate which then forms the second portion 103 preferably has a substantially constant thickness.

According to one embodiment, the second portion 103 may delimit an recess 109 participating in delimiting, with the recess 107 delimited by the first portion 102, the suction cavity 106 of the suction box 100 in the assembled configuration, as shown, for example, in FIGS. 5, 6, 7, 8, 18 and 19.

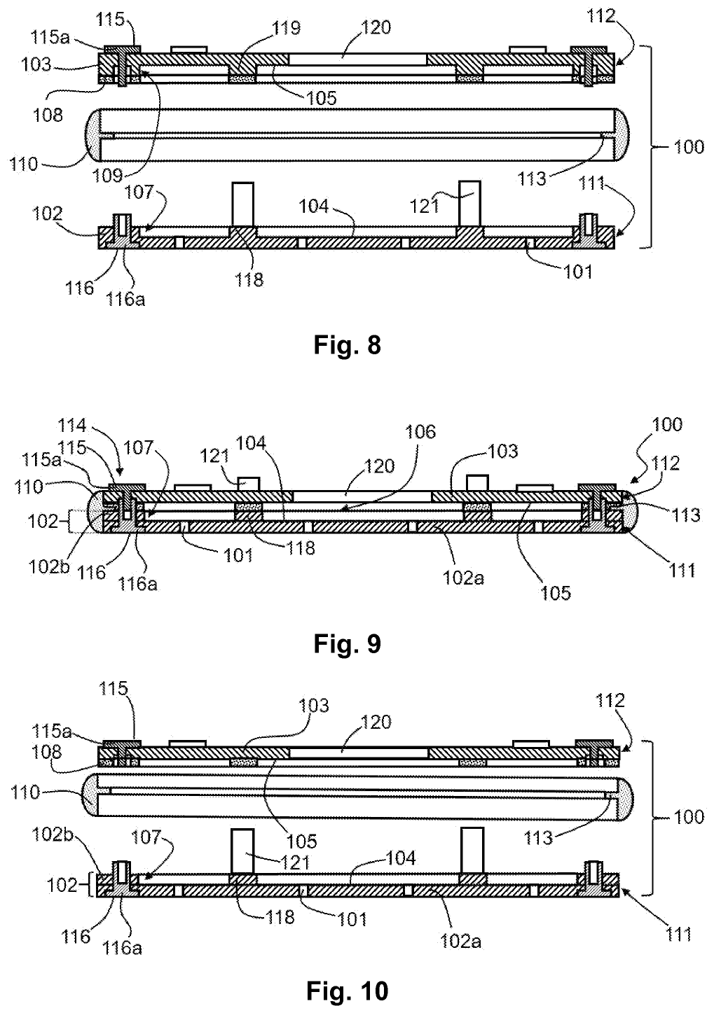

The second portion 103 may be a monolithic part (for example in the form of a plate with a variable thickness) as shown, for example, in FIGS. 7 and 8, and may for example be obtained by machining a plate. Alternatively, the second portion 103 may be formed by two parts 103a, 103b (FIGS. 5, 6, 18 and 19) bonded together so as to form the recess 109 of the second portion 103.

The two parts 103a, 103b of the second portion 103 may be bonded together by a two-component epoxy glue. A person skilled in the art will be able to use epoxy two-component glues well known per se, like for example LOCTITE® EA 9461 or ARALDITE® 2015-1.

The mentioned machining of the plate from which the second portion 103 may be derived may be carried out using a milling cutter.

The second portion 103 formed by two parts 103a, 103b may be obtained by bonding together a first plate with a second plate (thereby respectively forming the two parts 103a, 103b) cut in a suitable manner, for example, using a milling cutter in order to remove portions thereof so that cutting of the second plate allows, with the cooperation of the first plate, obtaining the recess 109 following bonding.

In particular, bonding two parts, whether to form the first portion 102 or the second portion 103, will be preferred because this will generally be faster than machining a complete plate to the desired shape and because this allows limiting the loss of material (the cut-out portions can be reused for other applications).

Machining is advantageous in the context of a gripper 1000 with a small-sized suction box 100 in order to reduce the manufacturing time in comparison with bonding different parts; this being of course true only if the ratio between the time of machining of a plate and the time of forming two suitable parts and then bonding them is strictly less than 1. Another advantage of machining is that it is possible to reduce the overall weight of the first portion 102 and, where appropriate, of the second portion 103, meaning that there is no need to provide for suitable dimensions of bonding surfaces to address a need for efficient bonding between two parts.

In general, the recess 109 of the second portion 103 may result from the fact that the periphery of the face of the second portion 103 delimiting the second wall 105 has a loop-shaped elevation obtained by milling or by one of the two parts 103a, 103b. This elevation participates with the second wall 105 in delimiting, in the assembled configuration, the suction cavity 106.

Preferably, the first portion 102 comprises a composite material comprising a matrix and fibers, in particular carbon fibers or Kevlar® fibers. This has the advantage of reinforcing the rigidity of the first portion 102.

Preferably, the second portion 103 comprises a composite material comprising a matrix and fibers, in particular carbon fibers or Kevlar® fibers. This has the advantage of reinforcing the rigidity of the second portion 103.

In particular, and that being so in a manner applicable to the composite material of the first portion 102 and/or of the second portion 103, the matrix may be made of an epoxy resin, of course in a hardened state.

The composite material may be the same for the first portion 102 and for the second portion 103, or the composite material of the first portion 102 may be different from the composite material of the second portion 103.

In the case where a monolithic part forms the first portion 102 or the second portion 103, the latter is then preferably made of the corresponding composite material.

If the first portion 102, or the second portion 103, is formed of two parts bonded together, each of these two parts may be made of a composite material as mentioned before.

As regards the aforementioned fibers, whether for the first portion 102 or for the second portion 103, each fiber may be selected from among: a carbon fiber, a glass fiber and an aramid fiber (for example Kevlar®). In other words, within each of the first and second portions 102, 103, the fibers may be made of the same material or of different materials. Such fibers have the advantage of ensuring a satisfactory rigidity of the suction box 100 while allowing limiting its weight. An advantage of carbon and/or glass and/or aramid fibers in the corresponding composite material is that this portion may have a greater deformation before alteration than if it was made of aluminum or steel.

The composite material may comprise a twill weave 3K formed by its fibers. In particular, it may consist of a twill carbon weave 3K.

According to a particular embodiment that could in particular be implemented for all or part of the different embodiments of the suction box 100, and for example as illustrated in FIGS. 2 to 18, 22 and 23, the suction box 100 may comprise a bumper 110 extending, in the assembled configuration, along a lateral edge 111 of the first portion 102 and a lateral edge 112 of the second portion 103, said bumper 110 comprising a compressed bead 113, in the assembled configuration, between the first and second portions 102, 103.

The bumper 110 may be made of EPDM or silicone and the bumper 110 may, for example, be in the form of a foam. EPDM or silicone each has the advantage of having a satisfactory flexibility, and more preferably still more flexibility in their foam form, to absorb and limit the consequences of an impact via the bumper 110.

Each of the lateral edge 111 of the first portion 102 and the lateral edge 112 of the second portion 103 participates in delimiting the aforementioned lateral peripheral edge.

In the assembled configuration, as shown for example in FIGS. 5, 7, 9, 11, the bead 113 may be pinched/compressed between the seal 108, in particular then fastened to the second portion 103, and the first portion 102 thereby holding of the bumper 110 with respect to the rest of the suction box 100.

Alternatively, as shown, for example, in FIG. 13 and FIG. 15, in the assembled configuration, the bead 113 may be pinched/compressed between the seal 108, in particular then fastened to the first portion 102, and the second portion 103, whereby holding of the bumper 110 with respect to the rest of the suction box 100.

The bumper 110 may also be such that the bead 113 actually forms the seal 108 as shown, for example, in FIG. 19. This allows limiting the overall number of elements necessary to manufacture the suction box 100. Of course, this principle could be applied to the different described embodiments.

Alternatively, the bumper 110 may be deprived of beads 113 and be bonded, for example via a double-sided adhesive, to one amongst the first and second portions 102, 103. According to still another alternative, the first and/or second portions 102, 103 may, in the assembled configuration, be such that they define a housing, for example obtained by suitable machining of the first and/or second portions 102, 103, in which a portion of the bumper 110 is fitted in order to enable holding of the bumper 110 with respect to the rest of the suction box 100.

We have talked before bout the mechanical connection which allows holding the suction box 100 in its assembled configuration. In fact, by “mechanical connection”, it should be understood any connection allowing holding the suction box 100 in its assembled configuration. The mechanical connection is reversible since it could be eliminated to obtain the disassembled configuration of the suction box 100. In the assembled configuration, the mechanical connection can hold the first portion 102 with respect to the second portion 103 so as to form a consistent whole and oppose a relative movement between the first portion 102 and the second portion 103. On the contrary, the elimination of the mechanical connection enables the independent handling of the first portion 102 and of the second portion 103, for example by moving them away from each other, whereby it is possible to easily access the interior of the suction box 100 and therefore the suction cavity 106, for example to clean the suction cavity 106.

Hence, there is a need to have an effective mechanical connection that is simple to implement, for example to facilitate the maintenance of the suction box 100. To this end, the suction box 100 may comprise assembly members 114 each comprising a male portion 115 comprising a support head 115a and a female portion 116 comprising a support head 116a. In the assembled configuration and for each assembly member 114, the male portion 115 of said assembly member 114 is fitted into the female portion 116 of said assembly member 114 so that the support head 115a of the male portion 115 of said assembly member 114 and the support head 116a of the female portion 116 of said assembly member 114 participate in the implementation of a bias of the first portion 102 and of the second portion 103 towards one another, in particular whereby the assembly member participates in the compression of the seal 108. Besides ensuring the desired holding of the first portion 102 with respect to the second portion 103, this also allows compressing the seal 108 in a manner suitable for ensuring the lateral sealing (i.e. parallel to the plane given by the axes X and Y in FIG. 3) of the suction box 100 in order to avoid pressure drops at the level of the lateral peripheral edge during gripping of object(s) 2000. In particular, the assembly members 114 extend throughout the suction box 100 and in particular through the first portion 102 and the second portion 103.

In particular, the female portion 116 may be in the form of an insert fastened to the first portion 102, or to the second portion 103, which then also comprises the orifices 101; in this case, the female portions 106 are preferably flush with the external surface of the suction box 100 (i.e. the female portions 116 do not project at the surface of one face of the suction box 100 where the member 1001 will be/is mounted in contact to facilitate mounting thereof). In this case, the support head 116a, also so-called the collar, of each female portion 116 may be accommodated entirely in the considered first portion 102 or second portion 103 and may be, or not, bonded thereto.

For example, the or each assembly member 114 may be such that its female portion 116 comprises an elongate body which extends from the support head 116a of said female portion 116, this elongate body of said female portion 116 being provided with a threaded hole to receive by screwing a tapped elongate body of the male portion 115 of said assembly member 114, the tapped elongate body extending from the support head 115a of said male portion 115.

The assembly members 114 may be distributed at the periphery of the suction box 100, this periphery being in particular that one according to a plane parallel to the axes X and Y of FIG. 3, so as to enable, in the assembled configuration, a suitable compression, in particular a homogeneous compression, of the seal 108 in order to avoid air leaks by the lateral peripheral edge.

For example, FIG. 3 shows the use of fourteen assembly members 114, which could of course be adapted according to the dimensions of the suction box 100.

According to a particular embodiment, the suction box 100 may comprise a third portion 117 arranged, in the assembled configuration, between the first portion 102 and the second portion 103. Thus, in the assembled configuration, the seal 108 may be compressed between the third portion 117 and the second portion 103 and more particularly between an edge 117a of the third portion 117 and the second portion 103. Moreover, in the assembled configuration, the suction box 100 comprises in this case an additional seal 108a compressed between the third portion 117 and the first portion 102 and more particularly between the edge 117a of the third portion 117 and the first portion 102. This additional seal 108 then also participates, in the assembled configuration, in sealing the suction cavity 106 between the first portion 102 and the second portion 103. In the assembled configuration, the third portion 117 allows increasing the volume of the suction cavity 106 in comparison with the volume of this suction cavity 106 if the suction box 100 was, in its assembled configuration, without the third portion 117. As a result, the suction box 100 is thicker, allowing for a larger volume of the suction cavity 106 enabling better object(s) gripping 2000, in particular porous to air, since by increasing the volume of the gripping cavity 106, the gripper 1000 can have a better power, although this is achieved to the detriment of the speed at which the object(s) 2000 can be grasped (i.e. loss of responsiveness of the gripper 1000).

Thus, the suction box 100 as described has the advantage of being modular meaning that the third portion 117 can be easily added where necessary to adjust the separation distance between the first and second portions 102, 103, for example like a spacer. Also, a plurality of third portions 117 may be stacked where necessary between the first and second portions 102, 103 to allow for a better adjustment of the volume of the suction cavity 106, one or more additional seal(s) should then be provided for in order to ensure, in the assembled configuration, sealing of the suction cavity 106 between the first portion 102 and the second portion 103.

In the disassembled configuration, unlike the assembled configuration, the first, second and third portions 102, 103, 117 can be handled independently and are therefore separated from one another.

In particular, the third portion 117 may be a plate cut across its thickness so that it comprises a loop-shaped edge participating in delimiting, in the assembled configuration, the suction cavity 106 and the lateral peripheral edge. In other words, the third portion 117 may be an apertured plate.

In the case where the third portion 117 is present, the seal 108 may be fastened, for example by bonding, in particular using a double-sided adhesive, to the second portion 103 (FIG. 17) and in particular on a face of the second portion 103 opposite the third portion 117 in the assembled configuration (FIG. 18); then, in the assembled configuration, the seal 108 is in contact with the third portion 117. Of course, alternatively, the seal 108 may be fastened, for example by bonding, in particular using a double-sided adhesive, to the third portion 117 on a face of the third portion 117 opposite the second portion 103 in the assembled configuration; then, in the assembled configuration, the seal 108 is in contact with the second portion 103. Still alternatively, the seal 108 may simply be in contact with the second portion 103 and the third portion 117 in the assembled configuration; then, in the disassembled configuration, the seal 108 may be handled independently with respect to the second and third portions 103, 117. The additional seal 108a may be fastened, for example by bonding in particular using a double-sided adhesive, to the third portion 117 (FIG. 17) and in particular on a face of the third portion 117 opposite the first portion 102 in the assembled configuration (FIG. 18); then, in the assembled configuration, the additional seal 108a is in contact with the first portion 102. Of course, alternatively, the additional seal 108a may be fastened, for example by bonding in particular using a double-sided adhesive, to the first portion 102 on a face of the first portion 102 opposite the third portion 117 in the assembled configuration; then, in the assembled configuration, the additional seal 108a is in contact with the third portion 117. Still alternatively, the additional seal 108a may simply be in contact with the first portion 102 and the third portion 117 in the assembled configuration; then, in the disassembled configuration, the additional seal 108a can be handled independently with respect to the first and third portions 102, 117.

The third portion 117 may comprise a composite material as described hereinabove. However, the third portion 117 may be made of another material, like, for example, a compact foam so as to oppose crushing thereof in the context of use of the suction box 100. The third portion 117 may be made of a fiber-based resin or may be obtained in 3D printing (also known as additive manufacturing) of any material suited to its function. The use of a foam as a third portion 117 could be possible if the rigidity of the suction box 100 ensured at least by the first portion 102 provided with its recess 107 and, where appropriate, by the second portion 103, in particular provided with its recess 109, is enough.

The additional seal 108a may be made of silicone EPDM and the additional seal 108a may, for example, be in the form of a foam. This is quite particularly suitable to ensure the desired sealing function.

The first portion 102 may comprise one or more rib(s) 118 (cf. for example FIGS. 4 to 19 and 23) which participate in the delimitation of the recess 107 of the first portion 102 and therefore to the shape of the suction cavity 106.

The second portion 103 may comprise one or more rib(s) 119 which participate in the delimitation of the recess 109 of the second portion 103 and therefore to the shape of the suction cavity 106.

The aforementioned rib(s) 118, 119 participate(s) in improving the overall rigidity of the suction box 100 by improving the rigidity of the first portion 102 and/or of the second portion 103.

Next, we talk about several ribs 118 that the first portion 102 could comprise; what applies for several ribs 118 of the first portion 102 could also be applied to one single rib 118 in the case where the first portion 102 comprises only this single rib 118. Where appropriate, we also talk hereinafter about several ribs 119 that the second portion 103 could comprise; what applies for several ribs 119 of the second portion 103 could also be applied to one single rib 119 in the case where the second portion 103 comprises only this single rib 119.

In particular, the ribs 118, 119 extend at the level of a bottom of the corresponding recess 107, 109, and therefore involve a decrease in the volume of the suction cavity 106 in the assembled configuration while allowing improving rigidity.

For example, the seal 108 may have a shape such that it is compressed, in the assembled configuration:
between an edge of a face of the first portion 102 and an edge of a face of the second portion 103, said edges adopting in particular the shape of a closed loop and said faces facing each other; and
between the ribs 118 of the first portion 102 and the second portion 103;
   thereby improving the overall rigidity of the suction box 100 since the ribs 118 and the seal 108 oppose crushing of the suction box 100 according to its thickness measurable according to the axis Z.

This compression of the seal 108 between the ribs 118 of the first portion 102 and the second portion 103 could be ensured when the second portion 103 is in the form of a plate, in particular with a substantially constant thickness, for example as illustrated in FIGS. 9, 11, 13 and 15.

In the case where the second portion 103 comprises the ribs 119, the compression of the seal 108 between the ribs 118 of the first portion 102 and the second portion 103 may be done more particularly between the ribs 118 of the first portion 102 and the ribs 119 of the second portion 103. In other words, the seal 108 may have a shape such that it is compressed, in the assembled configuration:
between the edge of the face of the first portion 102 and the edge of the face of the second portion 103, said edges adopting in particular the shape of a closed loop and said faces facing each other; and.
between the ribs 118 of the first portion 102 and the ribs 119 of the second portion 103, for example as illustrated in FIGS. 5 and 7;
   thereby improving the overall rigidity of the suction box 100 since the ribs 118, 119 and the seal 108 oppose crushing of the suction box 100 according to its thickness measurable according to the axis Z.

Besides the reinforcing function that the ribs 118, 119 confer, these allow refining the corresponding first portion 102 or the corresponding second portion 103 at the level of the bottom of the corresponding recess 107, 109. Thus, for example when the first portion 102 or the second portion 103 is formed by bonding two parts, the part forming the bottom of the corresponding recess 107, 106 may be a plate with a relatively thin thickness, for example comprised between 0.5 mm and 5 mm.

In the case where the third part 117 is present as shown in FIGS. 17 and 18, the third part 117 may comprise portions 117b, each interposed between a rib 118 of the first portion 102 and the second portion 103, and more particularly interposed between a rib 118 of the first portion 102 and a rib 119 of the second portion 103, so that for each portion 117b of the third part 117:
said portion 117b participates in the compression of the seal 108 between the second portion 103 and said portion 117b, and, where appropriate, between one of the ribs 119 of the second portion 103 and said portion 117b;
said portion 117b participates in the compression of the additional seal 108a between said portion 117b and one of the ribs 118 of the first portion 102.

This allows effectively opposing crushing of the suction box 100 according to its thickness. In particular, the portions 117b extend from the edge 117a of the third portion 117 to participate in delimiting the volume of the cavity 106 in the assembled configuration.

The invention also relates to a suction device 130 for the gripper 1000, said suction device 130 comprises a plurality of suction chambers. The suction device 100 comprises a plurality of suction boxes 100 as described, the suction cavity 106 of each of the suction boxes 100 corresponding to (i.e. forming) one amongst said suction chambers. The suction device 130 comprises a support 131 made in one-piece locally delimiting the first portions 102 or the second portions 13 of the suction boxes 100. For example, this allows having several independent suction cavities 106, for example to grasp different objects 2000. In particular, each suction box 100 could then be placed in fluidic communication with a vacuum generator 1002 that is specific thereto (i.e. each vacuum generator 1002 could then be coupled/associated with only one of the suction boxes 100).

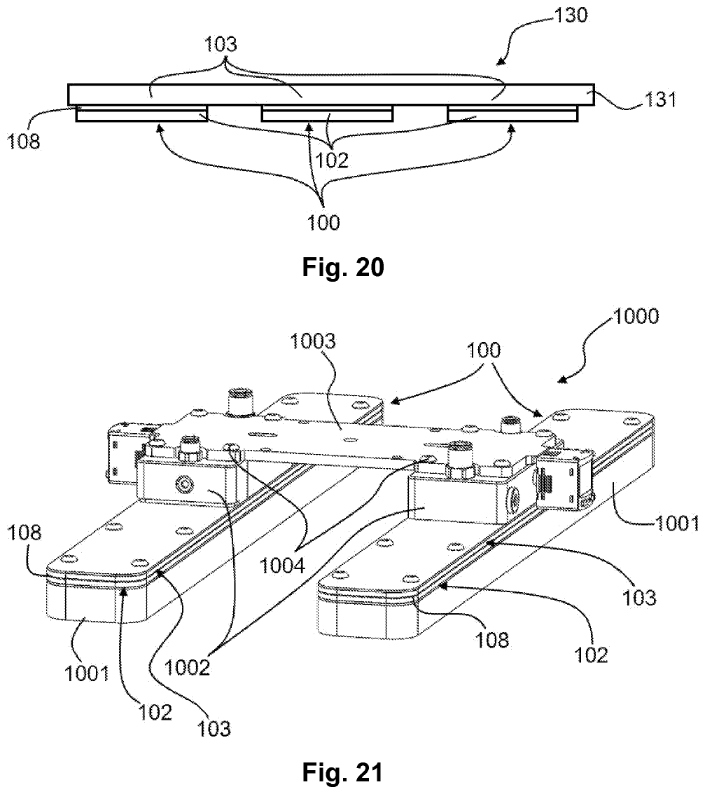

In particular, FIG. 20 shows the suction device 130 for which the support 131 locally delimits three second portions 103 each assembled to a corresponding first portion 102, the first portions 102 could be disassembled independently. For example, this allows facilitating maintenance by enabling opening of one suction cavity 106 at a time to clean it. The number of three second portions 103 herein is indicative, in particular more generally at least two are needed.

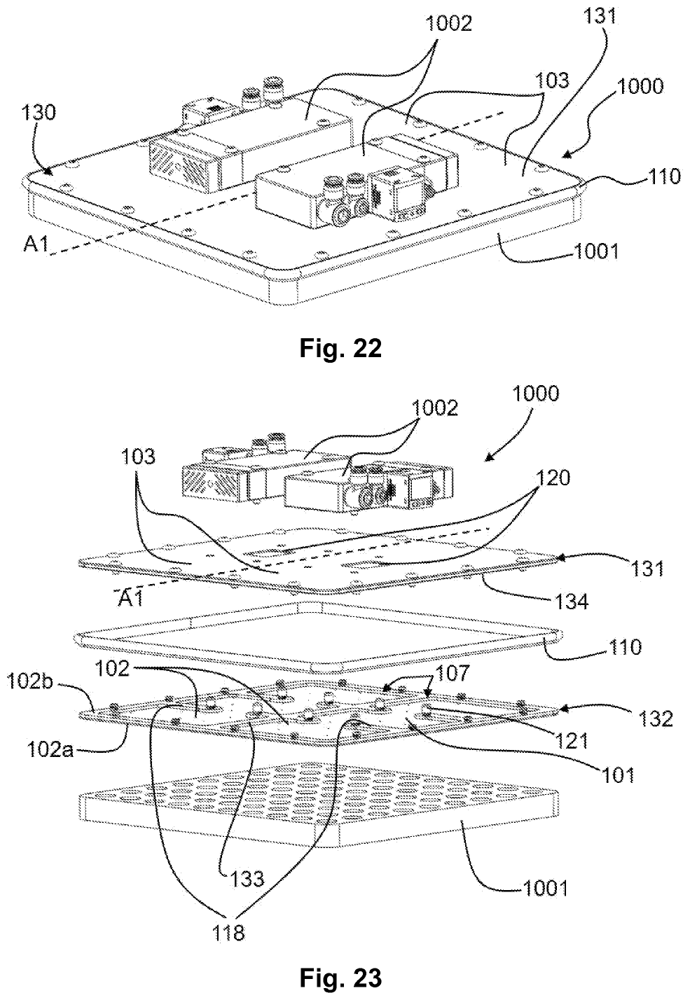

In particular, FIGS. 22 and 23 illustrate a particular embodiment of the suction device 130 within a gripper 1000 thereby the presence of the support 131 locally delimiting two second portions 103 schematically separated by a dotted line A1 and an element 132 made in one-piece locally delimiting two first portions 102 sharing a common partition 133 intended to participate in separating two suction cavities 106 when the support 131 and the element 132 are assembled with a seal 134 being interposed therebetween. The result of this is that the line A1 also schematizes the separation between two suction boxes 100 of the suction device 130. The seal 134 locally forms the seal 108 of one amongst the suction boxes 100 and the seal 108 of the other one amongst the suction boxes 100. In the example of FIGS. 22 and 23, the contact member 1001 is a foam common to the two suction boxes 100, for example encircled by the same bumper 110.

The invention also relates to the gripper 1000, the embodiments of which are illustrated in FIGS. 1, 2, 21, 22, 23. The gripper 1000 generally comprises:
at least one suction box 100 as described, FIGS. 1 and 2 show the gripper 1000 with one single suction box 100 whereas FIGS. 21, 22, 23 show the gripper 1000 with two suction boxes 100;
at least one contact member 1001 intended to come into contact with at least one object 200 to be grasped by the gripper 1000.

Said contact member 1001 is coupled/arranged, for example by gluing or mounting, to one amongst the first or second portions 102, 103 of said suction box 100. Said one amongst the first or second portions 102, 103 may comprise at least one suction orifice 101, and in particular several suction orifices 101, for sucking air at the level of the contact member 1001 towards the suction cavity 106 of said suction box 100.

In particular, FIG. 21 shows the gripper 1000 comprising two distinct boxes 100 each:
coupled to a contact member 1001 arranged at its first portion 102;
in fluidic communication with a vacuum generator 1002 which is specific thereto and fastened to its second portion 103.

The two suction boxes 100 are secured to each other using a connecting element 1003 comprised in the gripper 1000, this connecting element 1003 (for example formed by a bar) being fastened to the two vacuum generators 1002, for example using four screws 1004 for each vacuum generator 1002, these four screws could correspond to the screws 1002a mentioned hereinbefore, then they also serve to fasten said vacuum generator 1002 to the corresponding suction box 100.

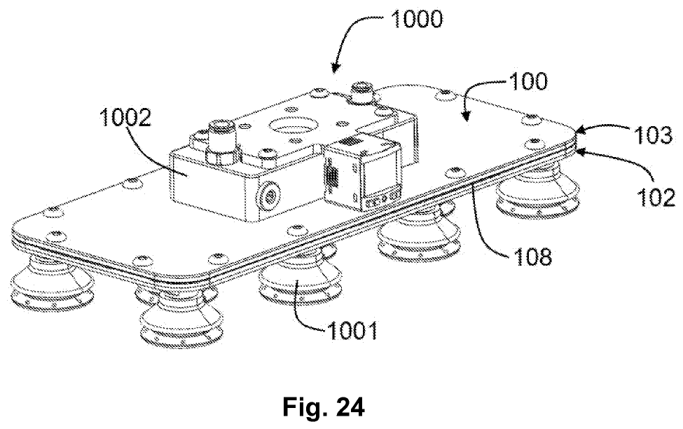

The contact member 1001 may be a foam as shown, for example, in FIGS. 1, 2, 21, 22, 23 or a suction cup as shown for example in FIG. 24 where each orifice 101 may be in fluidic communication with a corresponding suction cup.

In the case where the contact member 1001 is a foam, this foam may be fastened, for example by bonding using a double-sided adhesive, to the first portion 102 or to the second portion 103 which then comprises the orifices 101 so that each orifice 101 opens into a corresponding open-through hole of the foam, each open-through hole of the foam could be: in the continuity of one single orifice 101, and with a maximum lateral dimension (in particular considered parallel to the plane XY) strictly larger than the maximum lateral dimension (in particular considered parallel to the plane XY) of said orifice 101.

As a result of what has been described hereinbefore, the invention also relates to a method for manufacturing the suction box 100. The manufacturing method comprises a step of forming the first portion 102 of the suction box 100, a step of forming the second portion 103 of the suction box and an assembly step to obtain the assembled configuration of the suction box 100. The step of forming the first portion 102 comprises a step of machining, for example using a milling cutter, a plate to form the recess 107 or a step of assembling two plates, one of which is apertured, for example by cutting using a milling cutter, to participate in the formation of the recess 107.

Besides the advantages set out hereinbefore, the suction box 100 as described has the advantage of allowing streamlining the manufacture of the latter.

Indeed, it is then possible to store the different elements/parts/portions that form it and all it remains is to carry out the assembly on order: the stocks and the delivery delays are then optimized. Moreover, kits may be commercialized allowing assembling the suction box 100 and possibly the gripper 1000.

In particular, the suction box 100 finds industrial application in the field of robotic gripping of object(s) 2000, in particular in production lines where the objects 2000 should be handled while enabling easy maintenance of the suction box 100.

1. A suction box for a gripper, said suction box comprising a first portion and a second portion, one amongst the first and second portions being intended to be coupled to at least one contact member of the , said contact member being intended to come into contact with at least one object to be grasped by the gripper, and the other one amongst the first and second portions being intended to be in fluidic communication with a vacuum generator, the suction box being configured to selectively adopt:
an assembled configuration in which a mechanical connection is established between the first and second portions so as to delimit respectively a first wall of the suction box and a second wall of the suction box opposite to the first wall, each of the first and second walls partially defining, in the assembled configuration, a suction cavity of the suction box;
a disassembled configuration in which said mechanical connection is suppressed; wherein:
the first portion defines, in the assembled configuration and in the disassembled configuration, a recess;
the recess participates in delimiting, in the assembled configuration, the suction cavity of the suction box;
the suction box comprises a seal interposed, in the assembled configuration, between the first and second portions.

2. The suction box according to claim 1, wherein the first portion is a monolithic part.

3. The suction box according to claim 2, wherein the first portion is obtained by machining a plate.

4. The suction box according to claim 1, wherein the first portion is formed by two parts bonded together so as to delimit the recess.

5. The suction box according to claim 1, wherein the second portion is a plate.

6. The suction box according to claim 1, wherein the second portion delimits a recess participating in delimiting, with the recess delimited by the first portion, the suction cavity of the suction box in the assembled configuration.

7. The suction box according to claim 6, wherein the second portion is a monolithic part, or is formed by two parts bonded together so as to form the recess of the second portion.

8. The suction box according to claim 1, wherein the first portion comprises a composite material comprising a matrix and fibers, and/or the second portion comprises a composite material comprising a matrix and fibers.

9. The suction box according to claim 1, wherein it comprises a bumper extending, in the assembled configuration, along a lateral edge of the first portion and a lateral edge of the second portion, said bumper comprising a bead compressed, in the assembled configuration, between the first and second portions.

10. The suction box according to claim 9, wherein the seal is formed by the bead.

11. The suction box according to claim 1, wherein it comprises assembly members each comprising a male portion comprising a support head and a female portion comprising a support head, and in that, in the assembled configuration and for each assembly member, the male portion of said assembly member is fitted into the female portion of said assembly member so that the support head of the male portion of said assembly member and the support head of the female portion of said assembly member participate in the implementation of a bias of the first portion and of the second portion in the direction of one other.

12. The suction box according to claim 1, wherein it comprises a third portion arranged, in the assembled configuration, between the first portion and the second portion and in that, in the assembled configuration:
the seal is compressed between the third portion and the second portion;
the suction box comprises an additional seal compressed between the third portion and the first portion.

13. The suction box according to claim 1, wherein the first portion comprises at least one rib which participates in the delimitation of the recess.

14. A suction device for a gripper, said suction device comprises a plurality of suction chambers and a plurality of suction boxes each according to claim 1, the suction cavity of each of the suction boxes corresponding to one amongst said suction chambers and the suction device comprises a support made in one-piece locally delimiting the first portions or the second portions of the suction boxes.

15. A gripper, wherein it comprises:
at least one suction box according to claim 1;
at least one contact member intended to come into contact with at least one object to be grasped by the gripper; said contact member being coupled to one amongst the first or second portions of said suction box.

16. The gripper according to claim 15, wherein the contact member is a foam or a suction cup.

17. A method for manufacturing a suction box according to claim 1, wherein it comprises a step of forming the first portion of the suction box, a step of forming the second portion of the suction box and an assembly step to obtain the assembled configuration of the suction box, the step of forming the first portion comprising a step of machining a plate to form the recess or a step of assembling two plates, one of which is apertured to participate in the formation of the recess.
